(19) United States
(12) Patent Application Publication
(10) Pub. No.: US 2022/0244935 A1
(43) Pub. Date: Aug. 4, 2022

(54) CONFIGURABLE RULES APPLICATION PLATFORM

(71) Applicant: PeerStreet, Inc., El Segundo, CA (US)

(72) Inventors: Brewster Johnson, Manhattan Beach, CA (US); Igor Pstuga, Los Angeles, CA (US); Winnie Cheng, Los Angeles, CA (US); Evan William Sauer, Manhattan Beach, CA (US); Robert Rubenstein, Manhattan Beach, CA (US); Oren Ben Shaul, Manhattan Beach, CA (US)

(21) Appl. No.: 17/162,037

(22) Filed: Jan. 29, 2021

(51) Int. Cl. G06F 8/65; G06Q 40/02; G06N 5/02; G06Q 30/06

(52) U.S. Cl. CPC G06F 8/65; G06Q 30/0625; G06N 5/025; G06Q 40/025

(57) ABSTRACT

A web-based platform application for managing rules of a programming object is described. The platform application receives, from a client device, a definition of a product via a web page of a product configuration platform. The definition identifying attributes of the product. The platform application provides a rule configuration template in the web page of the product. The platform application receives entries in the rule configuration template. The entries indicate values for corresponding rule attributes of the rule configuration template. The platform application forms a product rule configuration based on the entries in the rule configuration template, and generates the programming object based on the definition of the product and the product rule configuration.

### TECHNICAL FIELD

The subject matter disclosed herein generally relates to a special-purpose machine that provides a platform to configure rules of a product including computerized variants of such special-purpose machines and improvements to such variants. Specifically, the present disclosure addresses systems and methods that generate a programming object that include product rules configuration validated by a rule engine.

### BACKGROUND

A lender can specify different criteria for a borrower to qualify for a loan program. For example, the lender can specify that the borrowed money is for real estate or automobile purchases. Other examples of criteria include geographic regions, loan terms, and minimum loan amount. Computer programs can be used to verify that a loan applicant meet the requirements of a loan program. However, it is difficult to change or custom define a set of rules of the loan program without re-programming the computer program. Typically, a software engineer receives a new set of rules for a new loan program and writes codes based on the new set of rules. Because rules and criteria can often change, it would take a considerable amount of time and resources for engineers to re-write the codes for each new set of rules or each new rule or logic change.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a product management application in accordance with one example embodiment.

FIG. 3 illustrates a rules engine in accordance with one example embodiment.

FIG. 4 illustrates a product matching engine in accordance with one example embodiment.

FIG. 5 illustrates an operation of a product tracking module in accordance with one example embodiment.

FIG. 6 illustrates an operation of a platform in accordance with one example embodiment.

FIG. 7 is a flow diagram illustrating a method for forming a programming object in accordance with one example embodiment.

FIG. 8 is a flow diagram illustrating a method for generating a programming object in accordance with one example embodiment.

FIG. 9 is a flow diagram illustrating a method for updating a programming object in accordance with one example embodiment.

FIG. 10 is a flow diagram illustrating a method for identifying validated products in accordance with one example embodiment.

FIG. 11 is a flow diagram illustrating a method for providing suggested parameters in accordance with one example embodiment.

FIG. 12 is a flow diagram illustrating a method for presenting ranked products in accordance with one example embodiment.

FIG. 13 is a flow diagram illustrating a method for recording a product instance identifier in accordance with one example embodiment.

FIG. 14 is a flow diagram illustrating a method for generating an alert notification in accordance with one example embodiment.

FIG. 15 illustrates an example of a loan product definition in accordance with one example embodiment.

FIG. 16 illustrates another example of a loan product definition in accordance with one example embodiment.

FIG. 17 illustrates an example of credit box settings in accordance with one example embodiment.

FIG. 18 illustrates an example of a product rule configuration in accordance with one example embodiment.

FIG. 19 illustrates another example of a product rule configuration in accordance with one example embodiment.

FIG. 20 illustrates an example of a product rule configuration in accordance with one example embodiment.

FIG. 21 illustrates an example of a product rule configuration in accordance with one example embodiment.

FIG. 22 illustrates an example of a product rule configuration in accordance with one example embodiment.

FIG. 23 illustrates an example of rule violations in accordance with one example embodiment.

FIG. 24 illustrates an example of rule violations in accordance with one example embodiment.

FIG. 25 is block diagram showing a software architecture within which the present disclosure may be implemented, according to an example embodiment,

FIG. 26 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Computer applications can be programmed to define criteria and rules for an item such as a product. For example, a platform application registers information about a product defined by a set of rules by a first user. The platform application stores the information in a database. The platform application receives a query from a second user. The query includes a set of requirements. The platform application searches the database and identifies the product that matches the set of requirements from the second user. The platform application surfaces the product to the second user.

The platform application can include a set of standard rules that are predefined and preprogrammed in the platform application. It may be difficult to change or custom define the set of rules without re-programming the platform application. Typically, a software engineer receives a new set of rules and writes codes based on the new set of rules. Because rules and criteria can often change, it would take a considerable amount of time and resources for engineers to write codes for each new set of rules or each new rule or logic change.

The present application describes a platform application that enables user to define a set of rules using a user-friendly user interface. The platform application defines the product based on the set of rules on the back end in response to rule definition entries from a user. For example, the platform application generates a programming object based on the rule definition without receiving codes written by a software engineer.

In one example embodiment, the product includes a financial product such as a loan program. One of ordinary skill in the art will appreciate that the product can also include non-financial product such as a device, a processing unit allocation, or a virtual memory space. The term “loan program” may refer to a type of loan or debt incurred by an individual or entity. The loan program can define borrowers' requirements as well as lenders' requirements. In one example, the loan program is defined based on three types of attributes: a product definition attribute, a product rules configuration attribute, and a product pricing attribute.

The product definition attribute defines a name and an active timeframe of the loan program. For example, the program name is “Extended Bridge”, and the active timeframe is “January 1, 2020-December 31, 2020.” In another example, the product definition attribute identifies a specific purpose of the loan program (e.g., refinancing) and a loan period (e.g., 5 years). One of ordinary skill in the art will appreciate that other characterization or definition of the loan program can be included in the product definition attribute.

The product rules configuration attribute defines a set of rules of the loan program. For example, the set of rules may define conditions of the loan program (e.g., parameters for a user to quality for a loan). The product rules configuration attribute may also be referred to a “credit box.” Example rules of the credit box include: a type of minimum loan-to-value ratio LTV), a minimum or maximum loan amount, an offer period (e.g., loan offer valid between dates), and a minimum credit score. The credit box can also include logic operators for the conditions.

The product pricing attribute defines a pricing or rate of the loan program. For example, the rate for loan program named “Extended Bridge” is 10%. In another example, the pricing or rate changes based on the conditions set forth in the credit box (e.g., interest rate increase if the LTV ratio increases).

The present application describes an application platform that provides a graphical user interface that enables a user to enter attribute data in the product definition attribute, the product rules configuration attribute, and the product pricing attribute corresponding to a loan program. The application platform generates a programming object based on the user-entered attribute data. The programming object represents the customized loan program.

In one example embodiment, the application platform receives attribute values (e.g., loan amount, loan purpose, credit score) from a user (e.g., a borrower). The application platform identifies a loan program based on the attribute values. In other words, the application platform identifies a loan program with conditions that satisfy the attribute values from the user. In one example, the application platform identifies valid and invalid conditions of a loan program based on the attribute values from the user. The application platform can also rank loan programs based on the number of conditions satisfied by the attribute values from the user.

In another example embodiment, the application platform generates a unique identifier for an instance of the loan program (e.g., Loan #123 from user A to user B). The application platform generates metadata for the loan program. The metadata identifies the credit box (e.g., conditions) of the loan program. As such, the application platform enables a user to search and identify the set of the rules associated with a loan based on the unique identifier (e.g., Loan #123).

In one example embodiment, the present application describes a web-based platform application for managing rules of a programming object is described. The platform application receives, from a client device, a definition of a product via a web page of a product configuration platform. The definition identifying attributes of the product. The platform application provides a rule configuration template in the web page of the product. The platform application receives entries in the rule configuration template. The entries indicate values for corresponding rule attributes of the rule configuration template. The platform application forms a product rule configuration based on the entries in the rule configuration template. The platform application generates the programming object based on the definition of the product and the product rule configuration.

As a result, one or more of the methodologies described herein facilitate solving the technical problem of changing a code of a program based on changing conditions set forth by a user. As such, one or more of the methodologies described herein may obviate a need for certain efforts or computing resources that otherwise would be involved in manually rewriting codes of a platform application. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

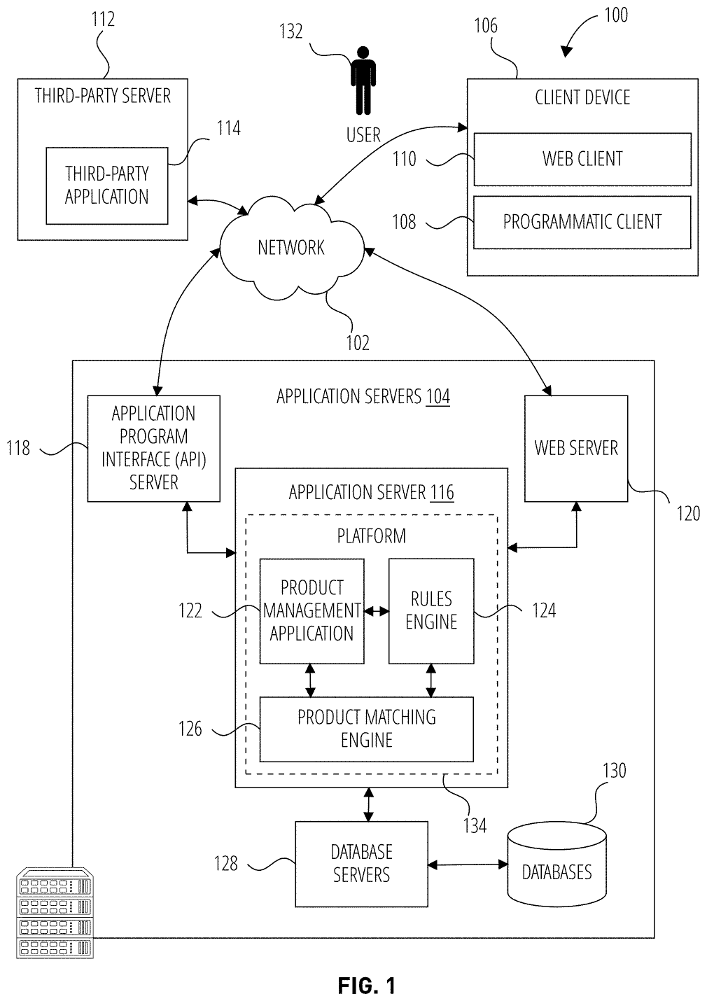

FIG. 1 is a diagrammatic representation of a network environment 100 in which some example embodiments of the present disclosure may be implemented or deployed.

One or more application servers 104 provide server-side functionality via a network 102 to a networked user device, in the form of a client device 106. A web client 110 (e.g., a browser) and a programmatic client 108 (e.g., an “app”) are hosted and execute on the client device 106.

An Application Program Interface (API) server 118 and a web server 120 provide respective programmatic and web interfaces to application servers 104. A specific application server 116 hosts a configurable product platform 134 (e.g., also referred to as a platform application), which includes components, modules and/or applications. In one example embodiment, the configurable product platform 134 includes a product management application 122, a rules engine 124, and a product matching engine 126.

The product management application 122 generates a graphical user interface that enables the user 132 to define a loan program, configure rules for the loan program, and price rates of the loan program. In one example embodiment, the product management application 122 generates a programming object, without the user 132 programming or writing code, based on a set of rules of a product defined by the user 132. For example, the user 132 uses the graphical user interface to custom define a name of a loan program (e.g., loan #123), a set of rules (e.g., rule 1, rule 2), logic between conditions of a rule (e.g., loan purpose AND LTV), and parameters of the conditions (e.g., loan purpose attribute is “refinance”, LTV is at least 50%).

The rules engine 124 validates the parameters of the conditions provided by the user 132. For example, the rules engine 124 verifies that there are no errors in the conditions and that the rules are compatible (e.g., LTV is −40%, minimum credit score is 100 where the lowest credit score can only be 300). In one example embodiment, the rules engine 124 identifies parameters that include attributes with errors and communicates the errors to the user 132.

The product matching engine 126 identifies a loan product with conditions/parameters that satisfy the attribute values provided by a user (e.g., a borrower). The product matching engine 126 receives attribute values (e.g., loan amount, loan purpose, credit score) from a borrower. The product matching engine 126 identifies a loan program based on the attribute values. In another example, the product matching engine 126 identifies valid and invalid conditions of a loan program based on the attribute values from the borrower. The product matching engine 126 can also rank loan programs based on the number of conditions satisfied by the attribute values from the borrower.

In another example embodiment, the product matching engine 126 generates a unique identifier for an instance of the loan program (e.g., Loan #123 from user A to user B). The product matching engine 126 generates metadata for the loan program. The metadata identifies the credit box (e.g., conditions) of the loan program. As such, the product matching engine 126 enables a user to search and identify the set of the rules associated with a loan based on the unique identifier (e.g., Loan #123).

The web client 110 communicates with the configurable product platform 134 via the web interface supported by the web server 120. Similarly, the programmatic client 108 communicates with the configurable product platform 134 via the programmatic interface provided by the Application Program Interface (API) server 118.

The application server 116 is shown to be communicatively coupled to database servers 128 that facilitates access to an information storage repository or databases 130. In an example embodiment, the databases 130 includes storage devices that store information to be published and/or processed by the configurable product platform 134.

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party.

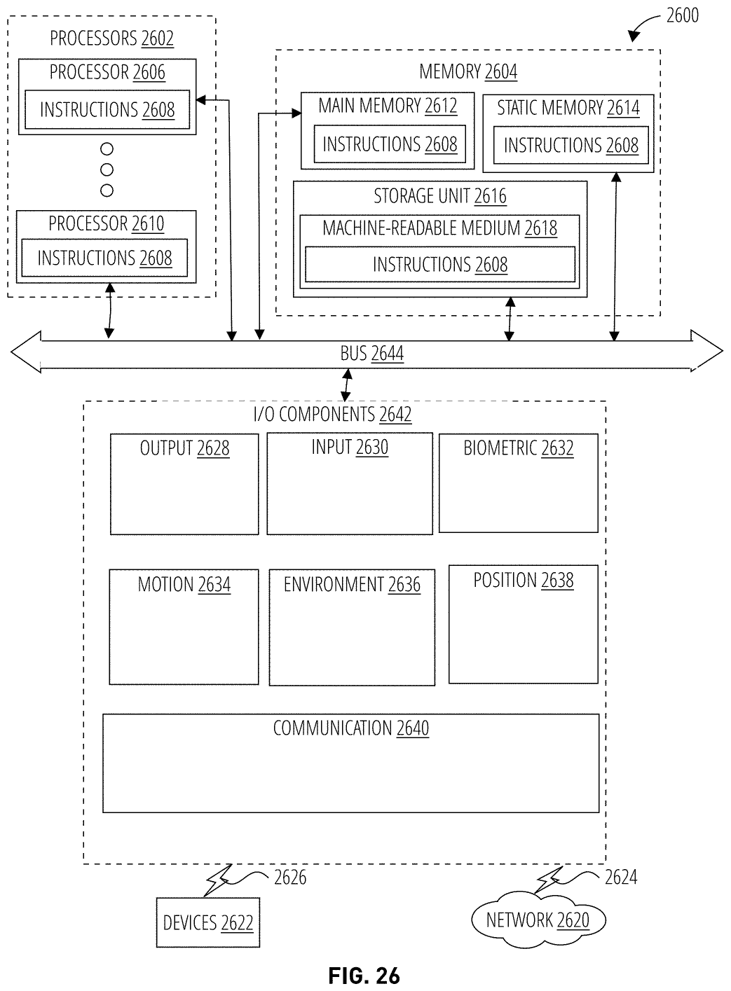

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 26, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

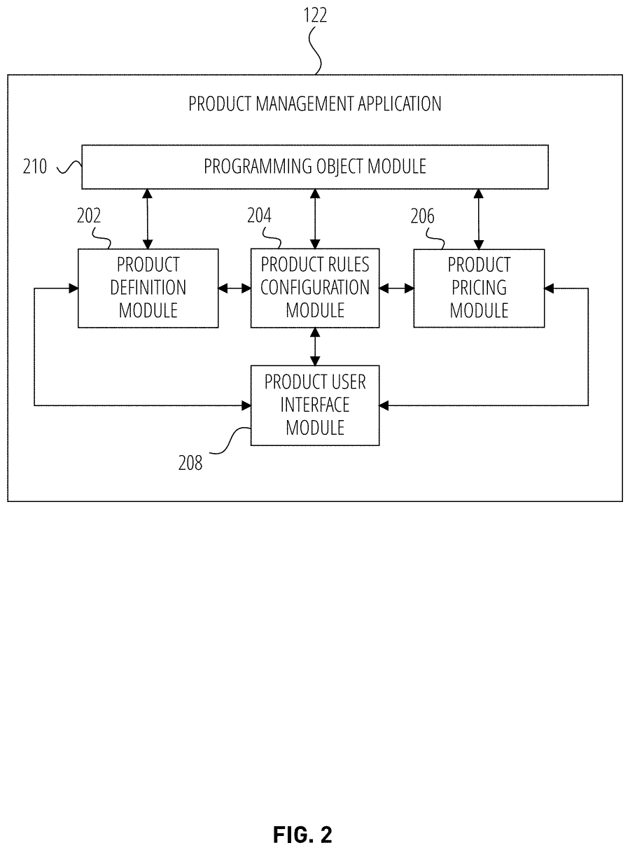

FIG. 2 illustrates the product management application 122 in accordance with one example embodiment. The product management application 122 generates a graphical user interface (GUI). The user 132 operates the product management application 122 via the GUI. For example, the user 132 uses the GUI to define a loan program, configure rules/parameters/logic for the loan program, and set price rates of the loan program. In one example embodiment, the product management application 122 generates a programming object, without the user 132 re-writing code of the product management application 122, based on a set of rules/parameters/logic of the loan program. In one example embodiment, the product management application 122 includes a product definition module 202, a product rules configuration module 204, a product pricing module 206, a product user interface module 208, and a programming object module 210.

The product definition module 202 defines definition attributes of the loan program. The definition attribute indicates the type of loan (e.g., a commercial bridge loan, a residential for rent loan, a multifamily loan), a user-defined name of the loan program, and a validity period of the loan program (e.g., effective date and expiration date).

The product rules configuration module 204 defines rules attributes and logic of the loan program. The rules attributes indicate logic operators and parameters. The rules attributes and logic operator combined may be referred to as the “credit box.” A credit box include a number of rules (e.g., maximum LTV, minimum FICO). For example, the rules attributes and logic of a maximum LTV rule includes the following parameters: the loan purpose attribute is “refinance,” the property value-to-median property value ratio attribute is “at least 2,” and the LTV ratio attribute is “at least 50%.” In another example, the credit box includes a validity attribute that defines the effective dates of the rules of the credit box. The credit box set forth requirements for a rule to be valid. If a rule is not valid, the credit box flags the non-valid rule.

In one example, the credit box includes logic operators (e.g., Boolean operators) between the attributes. In another example embodiment, the credit box is dynamic and is built around a core credit box. For example, a core credit box indicates a set of requirements. The user 132 can modify those requirements or include additional rules to the requirements. In another example embodiment, the credit box can include nested rules that refer to other existing rules.

In one example embodiment, the user 132 enters the parameters attributes and the corresponding values via a web-based GUI generated with the product user interface module 208. As such, the product rules configuration module 204 enables a user to customize the loan program without prior programming knowledge.

The product pricing module 206 defines a rate of the loan program based on the credit box. For example, the user 132 may set the rate at 5% for a first credit box and 6% for a second credit box. The rules of both the first and second credit boxes are different. In another example, the product pricing module 206 generates a table that maps rates to credit boxes.

The product user interface module 208 communicates with the product definition module 202, product rules configuration module 204, and product pricing module 206. The product user interface module 208 generates the GUI to enable the user 132 to define the loan program based on the operations of the product definition module 202, to define the rules of the loan program based on the operations of the product rules configuration module 204, and to define a rate of the loan program based on the operations of the product pricing module 206. In one example, the GUI includes user interface elements (e.g., dialog boxes, entry field boxes) that enable the user 132 to select attributes, enter the values for the selected attributes, and select logic operators between the selected attributes.

The programming object module 210 generates a programming object based on the data from the product rules configuration module 204, the product pricing module 206, and the product user interface module 208.

[@Ben—can we include an example code representative of a loan program with rules]

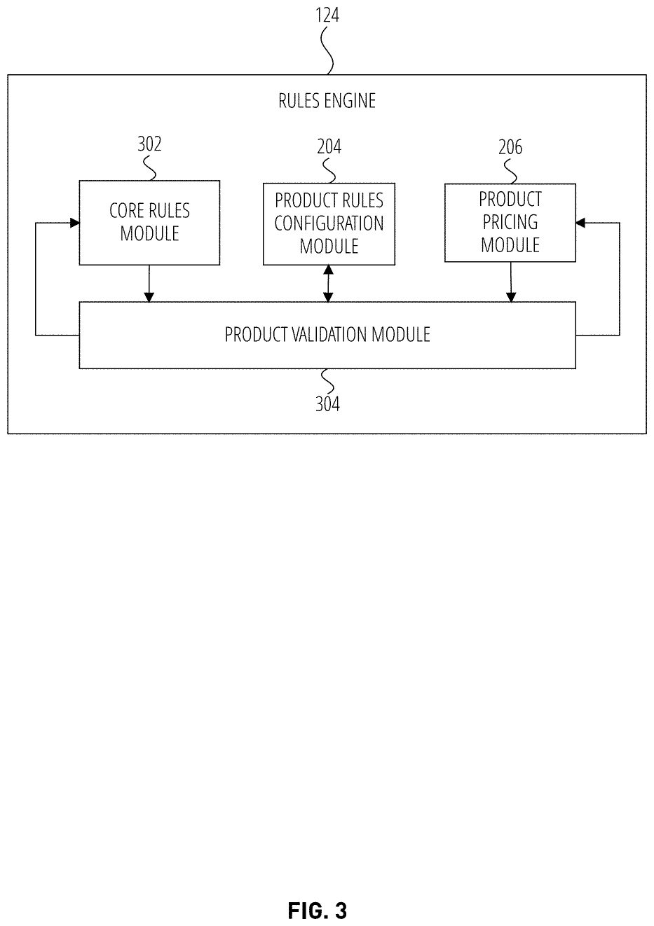

FIG. 3 illustrates the rules engine 124 in accordance with one example embodiment. The product rules engine 124 validates the parameters of the conditions provided by the user 132. In one example embodiment, the rules engine 124 identifies parameters that include attributes with errors and communicates the errors to the user 132.

In one example embodiment, the rules engine 124 includes a core rules module 302, the product rules configuration module 204, the product pricing module 206, and the product validation module 304. The product rules configuration module 204 and the product pricing module 206 are described above with respect to FIG. 2.

The core rules module 302 verifies that the rules and parameters set forth by the user 132 are valid. For example, the rules engine 124 verifies that there are no errors in the conditions and that the rules are compatible (e.g., LTV is −40%, minimum credit score is 100 where the lowest credit score can only be 300).

The product validation module 304 verifies that the logic in product rules configuration module 204 is valid and error-free. The product validation module 304 verifies that the rate is not valid (e.g., 100% loan interest rate is likely an error). In another example, the product validation module 304 detects that the interest rate should be lower (and not higher) for a lower LTV ratio in the rates set by the user 132 with the product pricing module 206.

In one example, the product validation module 304 indicates which rule or parameter is erroneous or invalid. In another example, the product validation module 304 verifies that logic and parameters of a new loan program built on a core loan program do not conflict with the logic and parameters of the core loan program. If the product validation module 304 detects conflict between nested rules, the product validation module 304 flags the error to the user 132. In another example, the product validation module 304 flags the value of an attribute because the value may exceed valid thresholds (e.g., an interest rate cannot be negative).

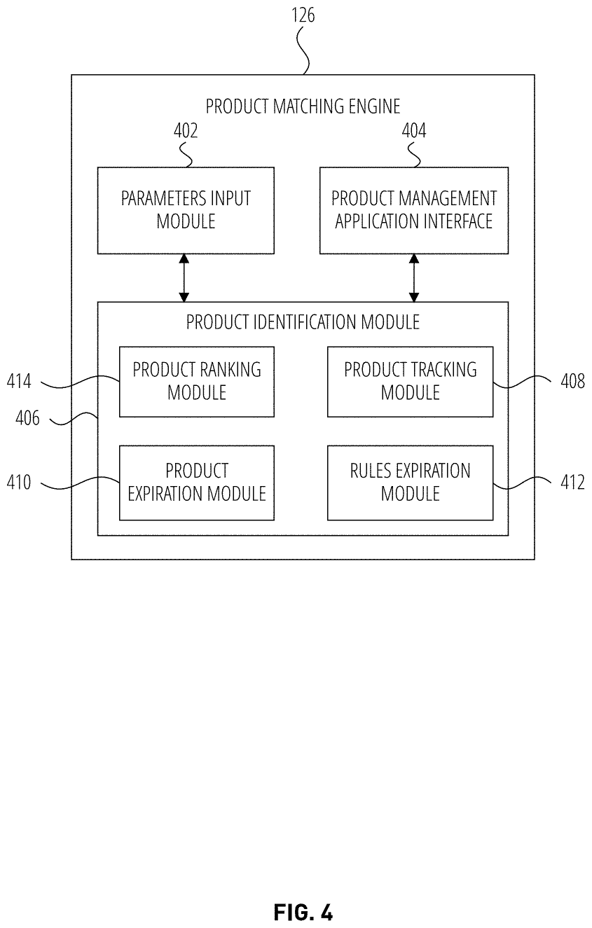

FIG. 4 illustrates the product matching engine 126 in accordance with one example embodiment. The product matching engine 126 identifies a loan program with conditions/parameters (from the credit box) that satisfy the attribute values provided by a user (e.g., a borrower). In one example embodiment, the product matching engine 126 includes a parameters input module 402, a product management applications 404, and a product identification module 406.

The parameters input module 402 receives attribute value from a loan applicant. Examples of attribute include a loan amount attribute, a loan purpose attribute, and a credit score attribute. One of ordinary skill in the art will appreciate that the parameters input module 402 queries other types of attributes (e.g., loan application profile, zip code, and so forth).

The following illustrates an example of code representing the attribute values of the parameters input module 402:

```
{“loan”:  {
“loan_originated_prior_to_submission_y_n”:  true,  “loan_purpose”:
“cash_out_refinance”,  “funding_strategy”:  “funded”,
“loan_strategy”:  “buy_to_rent”,  “junior_lien_holder”:  “peerstreet”,
“as_is_valuation”:  1000000,  “construction_reserve_at_origination”:
0,  “construction_reserve_disbursed_at_valuation”:  0,
“projected_rehab_budget”:  0,
“total_principal_balance_at_origination”:  500000,
“total_purchase_price”:  500000,  “total_principal_payments”:  0,
“interest_rate”:  10,  “interest_reserve_at_origination”:  0,
“lender_spread”:  1,  “b_piece_amount”:  0,  “pari_passu_amount”:  0,
“junior_liens_total_amount”:  0,  “extension_term”:  0,
“loan_origination_date”:  “1990-02-10”,
“projected_original_maturity_date”:  “1990-05-10”,
“original_maturity_date”:  “1990-05-10”,  “borrowers”:  [
  {  “borrower_type”:  “individual”,  “fico _score”:
750,  “guarantor_track_record”:  3,
“personal_guaranty”:  true,  “residency”:  “us_citizen”,
“liquidity”:  0
}  ],
“properties”:  [  {
      “address”:  “Rules Engine - Cash out Test”,  “city”:
“Denahaven”,  “postal_code”:  “91238”,
“property_type”:  “sfr”,
      “state”:  “CA”  }
],  “ltv”:  45,  “property_value_div_median_property_value”:  1
}
}
```

The product management application interface 404 communicates with the product management application 122. In one example, the product management applications 404 accesses the credit box and corresponding rules, parameters, and logic operators of a loan program. In one example embodiment, the product management applications 404 accesses a data storage (e.g., databases 130) that stores the programming objects representing the loan programs.

The product identification module 406 identifies one or more loan program that match the attribute values from the parameters input module 402. In one example, the product identification module 406 determines that the attribute values satisfy the conditions set forth in the credit box of the loan program. In an example operation, the product identification module 406 compares the attribute values with the parameters and rules defined by the credit box. The product identification module 406 also identifies valid and invalid conditions of the loan program based on the attribute values. For example, the product identification module 406 indicates that a minimum LTV attribute rule is not valid because the LTV attribute value from the user is less than the minimum LTV value from the rule. In one example embodiment, the product identification module 406 includes a product tracking module 408, a product expiration module 410, a rules expiration module 412, and a product ranking module 414.

The product tracking module 408 generates a unique identifier for an instance of the loan program (e.g., Loan #123 for user B for loan program xyz). In one example, the product matching engine 126 generates metadata for the loan program. The metadata identifies the credit box (e.g., conditions, rules, parameters, logic operators) of the loan program. As such, the product matching engine 126 enables a user (such as a lender) to search and identify the set of the rules/conditions associated with a loan based on the unique identifier (e.g., Loan #123). The programming object representing an instance of the loan program (e.g., Loan #123) includes the metadata. As such, every loan that is generated as a result of matching parameters input from a loan applicant can be tracked to identify which credit box/loan program was used to generate an instance of the loan program.

The following code illustrates an example of an identified loan program:

```
{  “status”: 200,
“data”:  [  {
        “loan_program”: {  “id”: “8ed9f2cd-2d69-
41d6-9aba-17767f1d70f4”,  “name”:  “Sandbox”,
“program_type”:  “residential_bridge”
        },  “creditbox”:  {
            “evaluation_status”: “succeeded”,
“evaluation_errors”: [ ],  “results”: [
                {  “message”: “Loan
exceeds max LTV of 45% (55%
standard plus reductions).”,  “severity”:
“error”
] }
} }
} ],
},  “pricing”:
“evaluation_status”:  “succeeded”,  “evaluation_errors”:  [ ],
“results”:  [
{ “name”:  “purchase_rate”,  “value”:  7.0 },
{ “name”:  “lender_spread”,  “value”:  1.0 }
```

The product expiration module 410 determines whether a loan program is still valid based on the effective valid dates of the loan program. For example, the conditions for a loan program may expire before the instance of the loan program is generated (e.g., a loan is generated based on the loan program). In one example, each loan program may have a corresponding expiration date.

The rules expiration module 412 determines whether a rule from the credit box is still valid based on the effective dates of the rule. In one example, each credit box may have a corresponding expiration date. In yet another example, each condition of a rule in the credit box may have a corresponding expiration date.

The product ranking module 414 generates a ranking of matching loan programs based on the number of conditions satisfied by the attribute values from the parameters input module 402. One of ordinary skill in the art will appreciate that the product ranking module 414 can generate other types of ranking (e.g., by interest rate, # of conditions of a loan program).

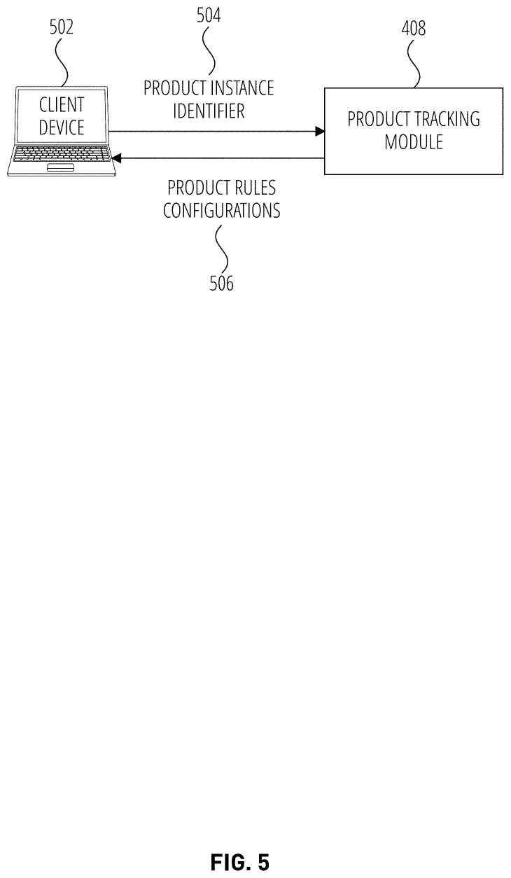

FIG. 5 illustrates an operation of the product tracking module 408 in accordance with one example embodiment. A client device 502 submits a query to the product tracking module 408. The query identifies a product instance identifier 504 (e.g., loan ID #123). The product tracking module 408 searches a database that maps loan identifiers with loan programs. The product tracking module 408 returns product rules configurations 506 (e.g., credit boxes, rules, parameters) to the client device 502. In one example, the product tracking module 408 references the corresponding credit box/timestamp of decision and submission of the loan applicant.

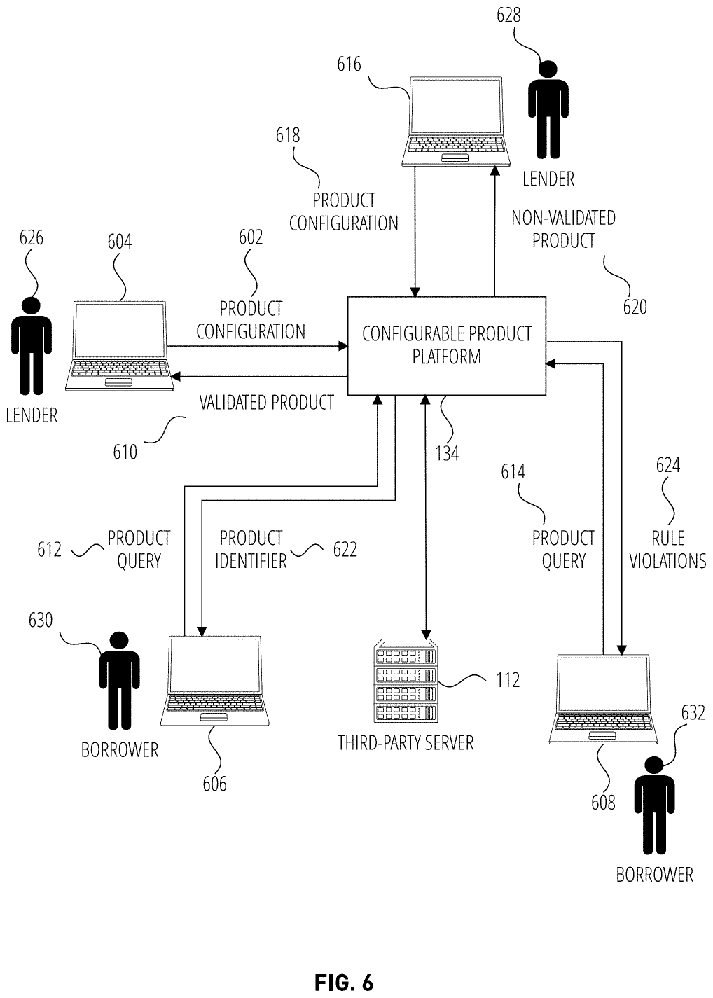

FIG. 6 illustrates an operation of the configurable product platform 134 in accordance with one example embodiment. A lender 626 operates a client device 604 to access the configurable product platform 134. The client device 604 provides a product configuration 602 (e.g., loan program with rules of a corresponding credit box) to the configurable product platform 134. The configurable product platform 134 verifies that the rules from the product configuration 602 are not in conflict with core rule, do not produce any errors, and are valid. Once the configurable product platform 134 determines that the rules of the credit box are valid, the configurable product platform 134 confirms the validated product 610 with the client device 604.

A lender 628 operates a client device 616 to access the configurable product platform 134. The client device 616 provides a product configuration 618 (e.g., loan program with rules of a corresponding credit box) to the configurable product platform 134. The configurable product platform 134 verifies that the rules from the product configuration 618 are not in conflict with core rules, do not produce any errors, and are valid. In this example, the configurable product platform 134 determines that one or more rules of the credit box are not valid. The configurable product platform 134 notifies the client device 616 of the non-validated product 620 (based on the product configuration 618).

A borrower 630 operates a client device 606 to access the configurable product platform 134. The client device 606 generates a product query 612 for a loan program at the configurable product platform 134. The product query 612 includes attribute values submitted by the borrower 630. The configurable product platform 134 identifies a loan program that matches the product query 612. The configurable product platform 134 notifies the client device 606 of the matching product identifier 622.

A borrower 632 operates a client device 608 to access the configurable product platform 134. The client device 608 generates a product query 614 for a loan program at the configurable product platform 134. The product query 614 includes attribute values submitted by the borrower 630. The configurable product platform 134 determines that no loan program matches the product query 612. For example, the configurable product platform 134 notifies the client device 608 of rule violations 624 and indicates which rules are violated.

In another example embodiment, portions of the configurable product platform 134 may be performed and operated from the third-party server 112. For example, product configuration validation or identification of rules violations can be performed at the third-party server 112.

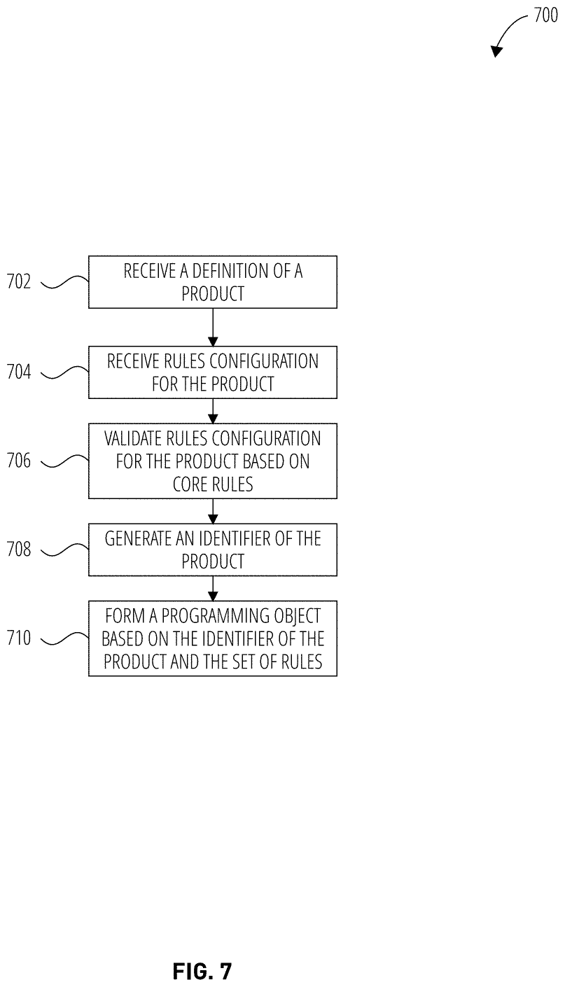

FIG. 7 is a flow diagram illustrating a method 700 for forming a programming object in accordance with one example embodiment. The method 700 may be performed by one or more computational devices, as described below. Operations in the method 700 may be performed by the product management application 122, using components (e.g., modules, engines) described above with respect to FIG. 2. Accordingly, the method 700 is described by way of example with reference to the product management application 122. However, it shall be appreciated that at least some of the operations of the method 700 may be deployed on various other hardware configurations or be performed by similar components residing elsewhere. For example, some of the operations may be performed at the third-party server 112.

In block 702, the product management application 122 receives a definition of a product. In one example embodiment, the product definition module 202 performs the operation of block 702. The operation of the product definition module 202 is described above in more detail with respect to FIG. 2.

In block 704, the product management application 122 receives rules configuration for the product. In one example embodiment, the product rules configuration module 204 performs the operation of block 704. The operation of the product rules configuration module 204 is described above in more detail with respect to FIG. 2.

In block 706, the product management application 122 validates rules configuration for the product based on core rules. In one example embodiment, the product rules configuration module 204 performs the operation of block 706. The operation of the product rules configuration module 204 is described above in more detail with respect to FIG. 2.

In block 708, the product management application 122 generates an identifier of the product. In one example embodiment, the product rules configuration module 204 performs the operation of block 708. The operation of the product rules configuration module 204 is described above in more detail with respect to FIG. 2.

In block 710, the product management application 122 generates a programming object based on the identifier of the product and the set of rules. In one example embodiment, the programming object module 210 performs the operation of block 702. The operation of the programming object module 210 is described above in more detail with respect to FIG. 2.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

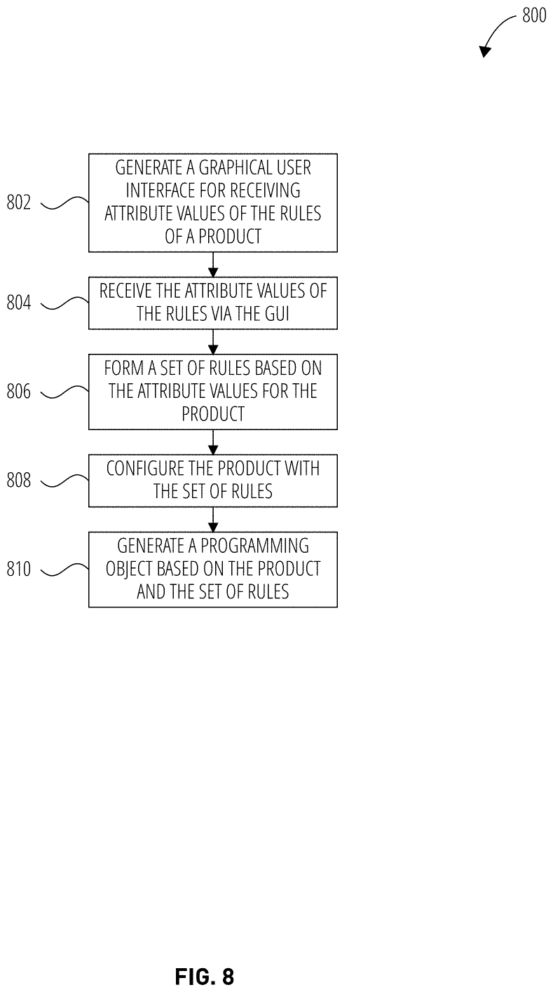

FIG. 8 is a flow diagram illustrating a method 800 for generating a programming object in accordance with one example embodiment. The method 800 may be performed by one or more computational devices, as described below. Operations in the method 800 may be performed by the product management application 122, using Components (e.g., modules, engines) described above with respect to FIG. 2. Accordingly, the method 800 is described by way of example with reference to the product management application 122. However, it shall be appreciated that at least some of the operations of the method 800 may be deployed on various other hardware configurations or be performed by similar Components residing elsewhere. For example, some of the operations may be performed at the third-party server 112.

In block 802, the product management application 122 generates a graphical user interface for receiving attribute values of the rules of a product. In one example embodiment, the product user interface module 208 performs the operation of block 802. The operation of the product user interface module 208 is described above in more detail with respect to FIG. 2.

In block 804, the product management application 122 receives the attribute values of the rules via the GUI. In one example embodiment, the product rules configuration module 204 performs the operation of block 804. The operation of the product rules configuration module 204 is described above in more detail with respect to FIG. 2.

In block 806, the product rules configuration module 204 forms a set of rules based on the attribute values for the product. In one example embodiment, the product rules configuration module 204 performs the operation of block 806. The operation of the product rules configuration module 204 is described above in more detail with respect to FIG. 2.

In block 808, the product management application 122 configures the product with the set of rules. In one example embodiment, the product rules configuration module 204 performs the operation of block 808. The operation of the product rules configuration module 204 is described above in more detail with respect to FIG. 2.

In block 810, the product management application 122 generates a programming object based on the product and the set of rules. In one example embodiment, the programming object module 210 performs the operation of block 808. The operation of the programming object module 210 is described above in more detail with respect to FIG. 2.

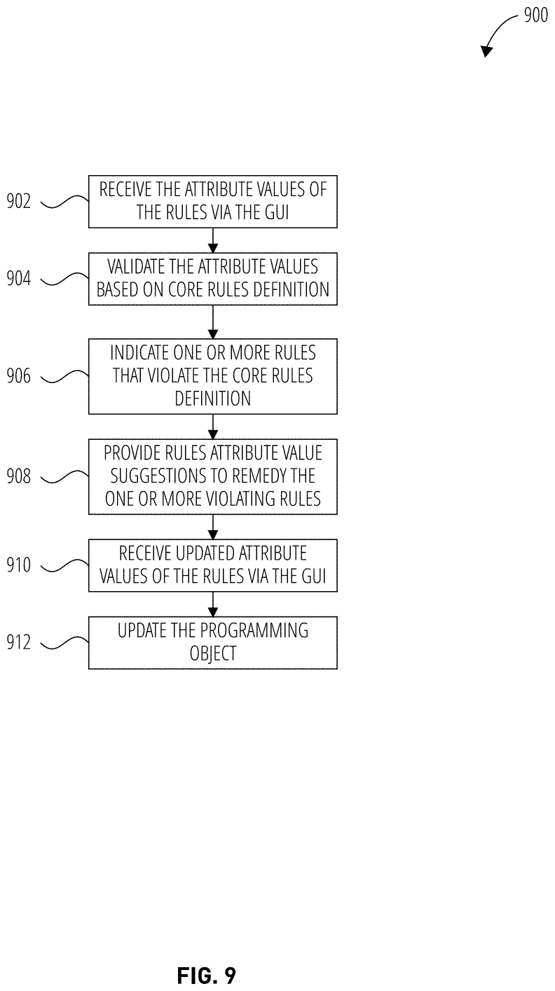

FIG. 9 is a flow diagram illustrating a method 900 for updating a programming object in accordance with one example embodiment. The method 900 may be performed by one or more computational devices, as described below. Operations in the method 900 may be performed by the rules engine 124, using Components (e.g., modules, engines) described above with respect to FIG. 3. Accordingly, the method 900 is described by way of example with reference to the rules engine 124. However, it shall be appreciated that at least some of the operations of the method 900 may be deployed on various other hardware configurations or b e performed by similar Components residing elsewhere. For example, some of the operations may be performed at the third-party server 112.

In block 902, the rules engine 124 receives the attribute values of the rules via the GUI. In one example embodiment, the product rules configuration module 204 performs the operation of block 902. The operation of the product rules configuration module 204 is described above in more detail with respect to FIG. 2.

In block 904, the rules engine 124 validates the attribute values based on core rules definition. In one example embodiment, the product validation module 304 performs the operation of block 904. The operation of the product validation module 304 is described above in more detail with respect to FIG. 3.

In block 906, the rules engine 124 indicates one or more rules that violate the core rules definition. In one example embodiment, the product validation module 304 performs the operation of block 906. The operation of the product validation module 304 is described above in more detail with respect to FIG. 3.

In block 908, the rules engine 124 provides rules attribute value suggestions to remedy the one or more violating rules. In one example embodiment, the product validation module 304 performs the operation of block 908. The operation of the product validation module 304 is described above in more detail with respect to FIG. 3.

In block 910, the rules engine 124 receives updated attribute values of the rules via the GUI. In one example embodiment, the product rules configuration module 204 performs the operation of block 910. The operation of the product rules configuration module 204 is described above in more detail with respect to FIG. 2.

In block 912, the rules engine 124 updates the programming object. In one example embodiment, the product rules configuration module 204 performs the operation of block 912. The operation of the product rules configuration module 204 is described above in more detail with respect to FIG. 2.

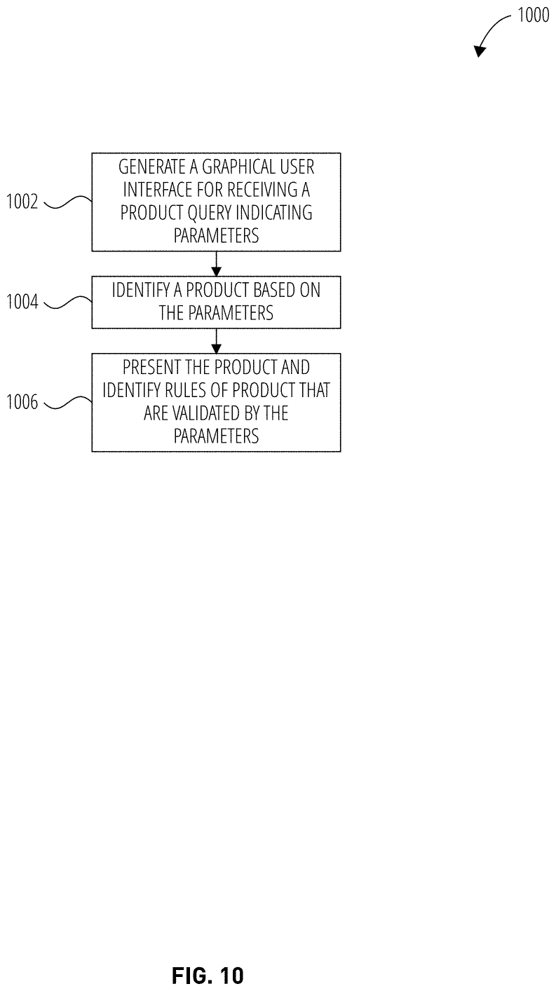

FIG. 10 is a flow diagram illustrating a method 1000 for identifying validated products in accordance with one example embodiment. The method 1000 may be performed by one or more computational devices, as described below. Operations in the method 1000 may be performed by the product matching engine 126, using Components (e.g., modules, engines) described above with respect to FIG. 4. Accordingly, the method 1000 is described by way of example with reference to the product matching engine 126. However, it shall be appreciated that at least some of the operations of the method 1000 may be deployed on various other hardware configurations or be performed by similar Components residing elsewhere. For example, some of the operations may be performed at the third-party server 112.

In block 1002, the product matching engine 126 generates a graphical user interface for receiving a product query indicating parameters. In one example embodiment, the parameters input module 402 performs the operation of block 1002. The operation of the parameters input module 402 is described above in more detail with respect to FIG. 4.

In block 1004, the product matching engine 126 identifies a product based on the parameters. In one example embodiment, the product identification module 406 performs the operation of block 1004. The operation of the product identification module 406 is described above in more detail with respect to FIG. 4.

In block 1006, the product matching engine 126 presents the product and identifies rules of product that are validated by the parameters. In one example embodiment, the product identification module 406 performs the operation of block 1006. The operation of the product identification module 406 is described above in more detail with respect to FIG. 4.

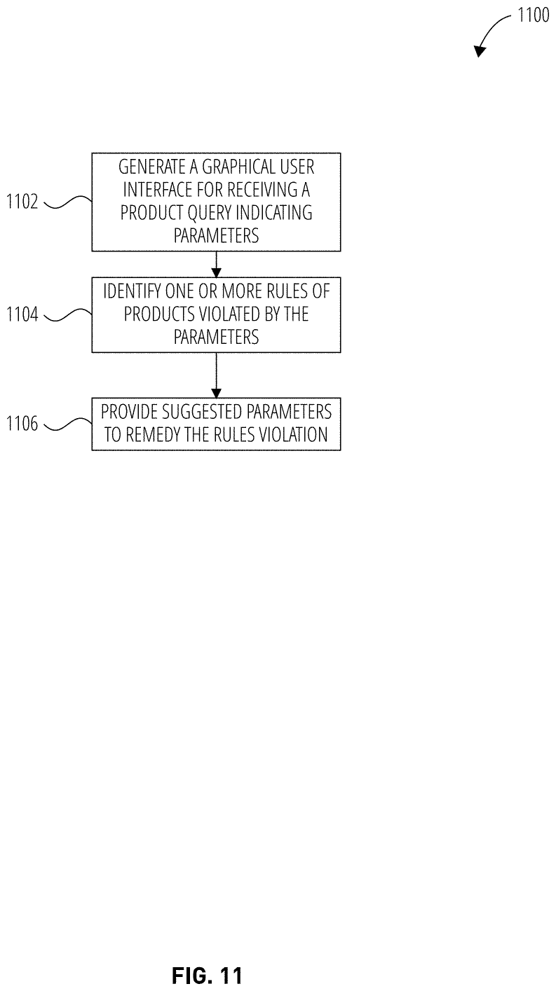

FIG. 11 is a flow diagram illustrating a method 1100 for providing suggested parameters in accordance with one example embodiment. The method 1100 may be performed by one or more computational devices, as described below. Operations in the method 1100 may be performed by the product matching engine 126, using Components (e.g., modules, engines) described above with respect to FIG. 4. Accordingly, the method 1100 is described by way of example with reference to the product matching engine 126. However, it shall be appreciated that at least some of the operations of the method 1100 may be deployed on various other hardware configurations or be performed by similar Components residing elsewhere. For example, some of the operations may be performed at the third-party server 112.

In block 1102, the product matching engine 126 generates a graphical user interface for receiving a product query indicating parameters. In one example embodiment, the parameters input module 402 performs the operation of block 1102. The operation of the parameters input module 402 is described above in more detail with respect to FIG. 4.

In block 1104, the product matching engine 126 identifies one or more rules of products violated by the parameters. In one example embodiment, the product identification module 406 performs the operation of block 1104. The operation of the product identification module 406 is described above in more detail with respect to FIG. 4.

In block 1106, the product matching engine 126 provides suggested parameters to remedy the rules violation. In one example embodiment, the product identification module 406 performs the operation of block 1106. The operation of the product identification module 406 is described above in more detail with respect to FIG. 4.

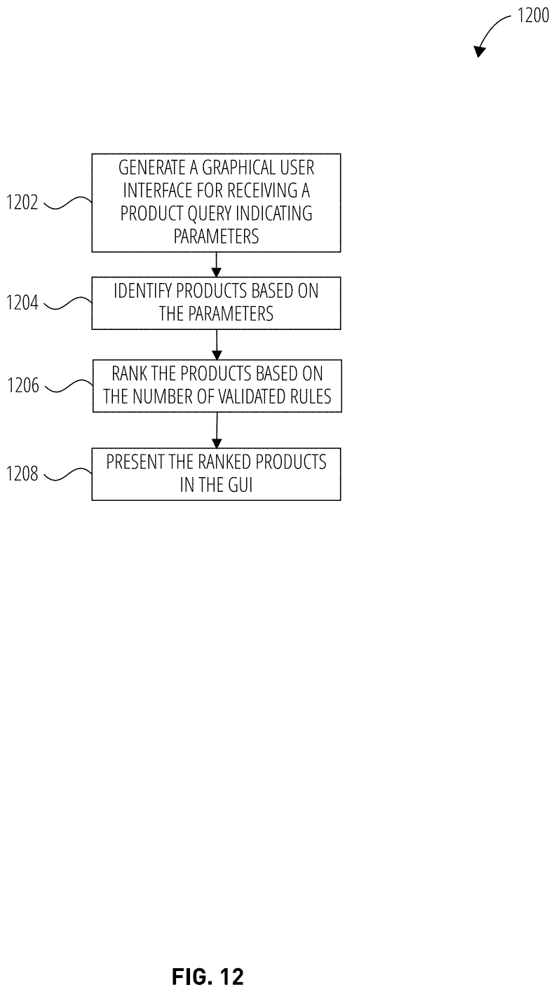

FIG. 12 is a flow diagram illustrating a method 1200 for presenting ranked products in accordance with one example embodiment. The method 1200 may be performed by one or more computational devices, as described below. Operations in the method 1200 may be performed by the product matching engine 126, using Components (e.g., modules, engines) described above with respect to FIG. 4. Accordingly, the method 1200 is described by way of example with reference to the product matching engine 126. However, it shall be appreciated that at least some of the operations of the method 1200 may be deployed on various other hardware configurations or be performed by similar Components residing elsewhere. For example, some of the operations may be performed at the third-party server 112.

In block 1202, the product matching engine 126 generates a graphical user interface for receiving a product query indicating parameters. In one example embodiment, the parameters input module 402 performs the operation of block 1206. The operation of the parameters input module 402 is described above in more detail with respect to FIG. 4.

In block 1204, the product matching engine 126 identifies products based on the parameters. In one example embodiment, the product identification module 406 performs the operation of block 1204. The operation of the product identification module 406 is described above in more detail with respect to FIG. 4.

In block 1206, the product matching engine 126 ranks the products based on the number of validated rules. In one example embodiment, the product ranking module 414 performs the operation of block 1206. The operation of the product ranking module 414 is described above in more detail with respect to FIG. 4.

In block 1208, the product matching engine 126 presents the ranked products in the GUI. In one example embodiment, the product identification module 406 performs the operation of block 1208. The operation of the product identification module 406 is described above in more detail with respect to FIG. 4.

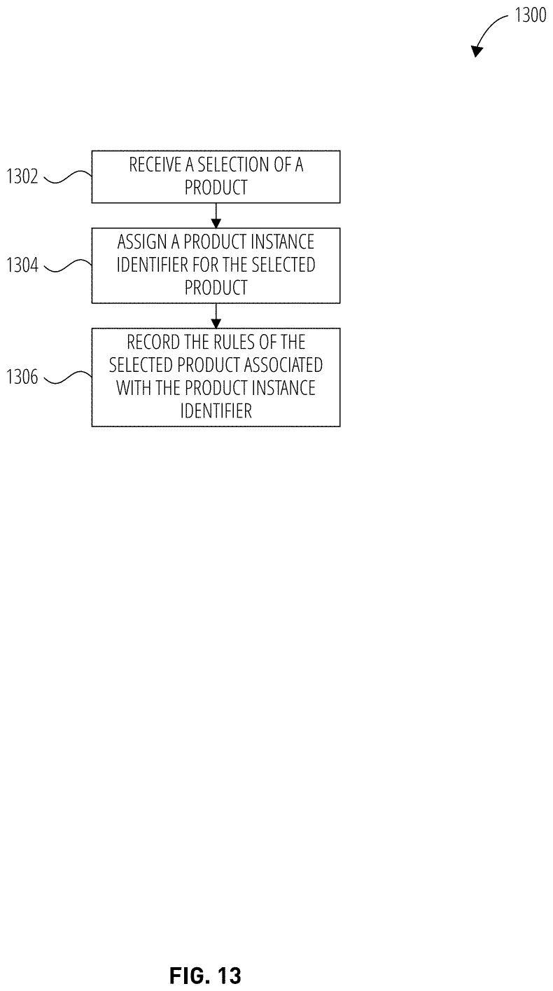

FIG. 13 is a flow diagram illustrating a method 1300 for recording a product instance identifier in accordance with one example embodiment. The method 1300 may be performed by one or more computational devices, as described below. Operations in the method 1300 may be performed by the product matching engine 126, using Components (e.g., modules, engines) described above with respect to FIG. 4. Accordingly, the method 1300 is described by way of example with reference to the product matching engine 126. However, it shall be appreciated that at least some of the operations of the method 1300 may be deployed on various other hardware configurations or be performed by similar Components residing elsewhere. For example, some of the operations may be performed at the third-party server 112.

In block 1302, the product matching engine 126 receives a selection of a product. In one example embodiment, the product identification module 406 performs the operation of block 1302. The operation of the product identification module 406 is described above in more detail with respect to FIG. 4.

In block 1304, the product matching engine 126 assigns a product instance identifier for the selected product. In one example embodiment, the product tracking module 408 performs the operation of block 1304. The operation of the product tracking module 408 is described above in more detail with respect to FIG. 4.

In block 1306, the product matching engine 126 records the rules of the selected product associated with the product instance identifier. In one example embodiment, the product tracking module 408 performs the operation of block 1306. The operation of the product tracking module 408 is described above in more detail with respect to FIG. 4.

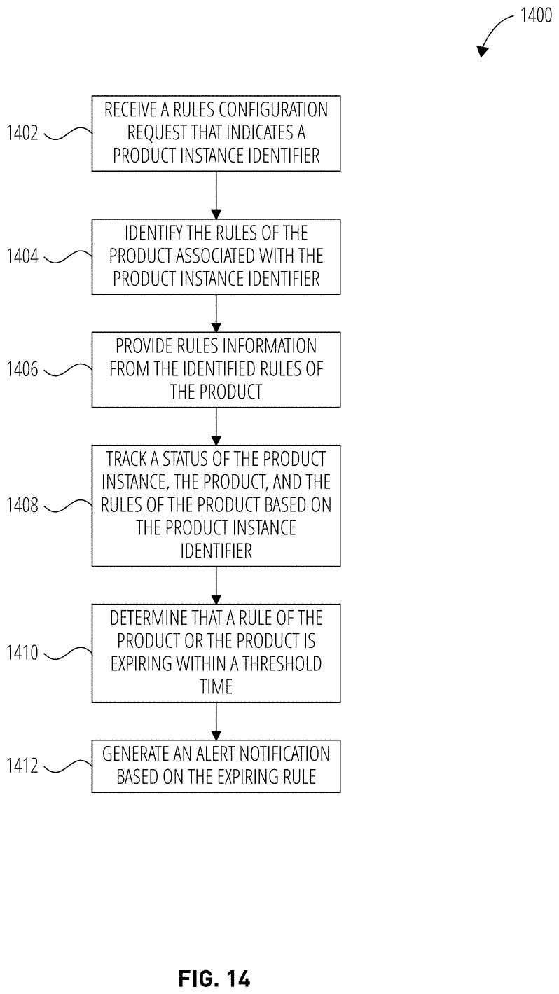

FIG. 14 is a flow diagram illustrating a method for generating an alert notification in accordance with one example embodiment. The method 1400 may be performed by one or more computational devices, as described below. Operations in the method 1400 may be performed by the rules engine 124 and the product matching engine 126, using Components (e.g., modules, engines) described above with respect to FIG. 4. Accordingly, the method 1400 is described by way of example with reference to the rules engine 124 and the product matching engine 126. However, it shall be appreciated that at least some of the operations of the method 1400 may be deployed on various other hardware configurations or be performed by similar Components residing elsewhere. For example, some of the operations may be performed at the third-party server 112.

In block 1402, the product tracking module 408 receives a rules configuration request that indicates a product instance identifier. The operation of the product tracking module 408 is described above in more detail with respect to FIG. 4.

In block 1404, the product tracking module 408 identifies the rules of the product associated with the product instance identifier. The operation of the product tracking module 408 is described above in more detail with respect to FIG. 4.

In block 1406, the product tracking module 408 provides rules information from the identified rules of the product. The operation of the product tracking module 408 is described above in more detail with respect to FIG. 4.

In block 1408, the product tracking module 408 tracks a status of the product instance, the product, and the rules of the product based on the product instance identifier. The operation of the product tracking module 408 is described above in more detail with respect to FIG. 4.

In block 1410, the product validation module 304 determines that a rule of the product or the product is expiring within a threshold time. The operation of the product validation module 304 is described above in more detail with respect to FIG. 3.

In block 1412, the product validation module 304 generates an alert notification based on the expiring rule. The operation of the product validation module 304 is described above in more detail with respect to FIG. 3.

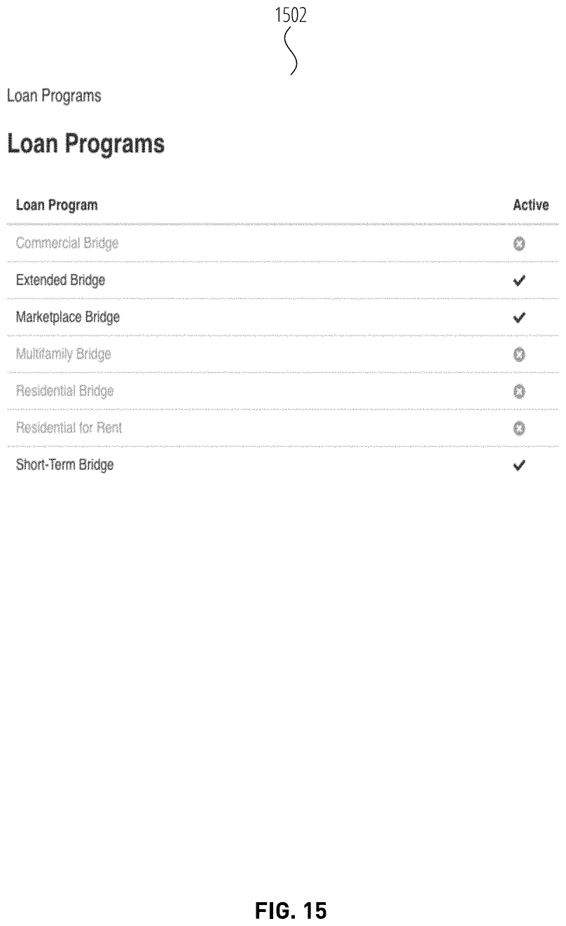

FIG. 15 illustrates an example of a loan product definition in accordance with one example embodiment. The loan programs 1502 includes, for example, a list of active and inactive types of loans.

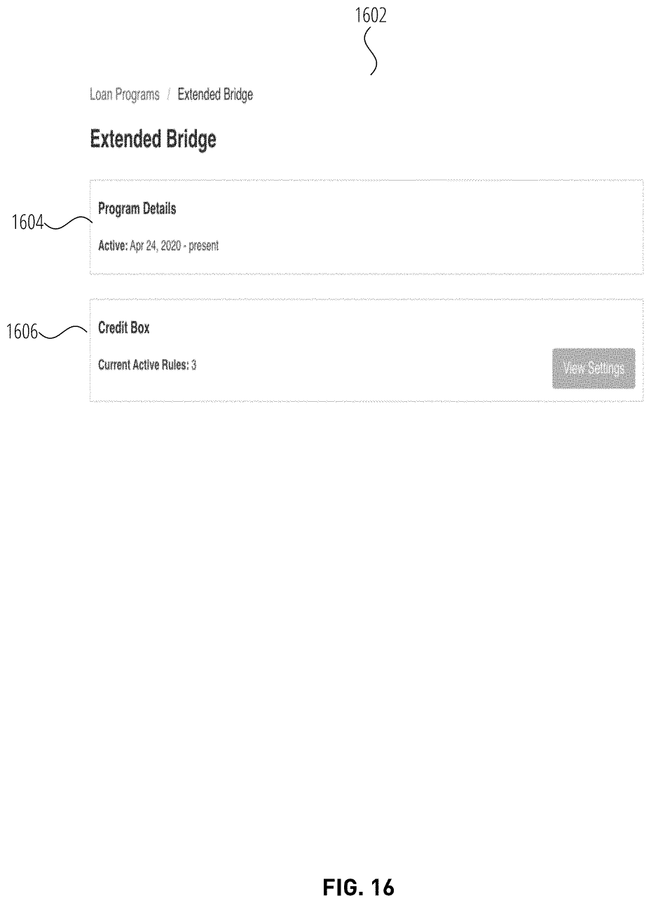

FIG. 16 illustrates another example of a loan product definition in accordance with one example embodiment. The loan program 1602 describes program details 1604 and a credit box 1606.

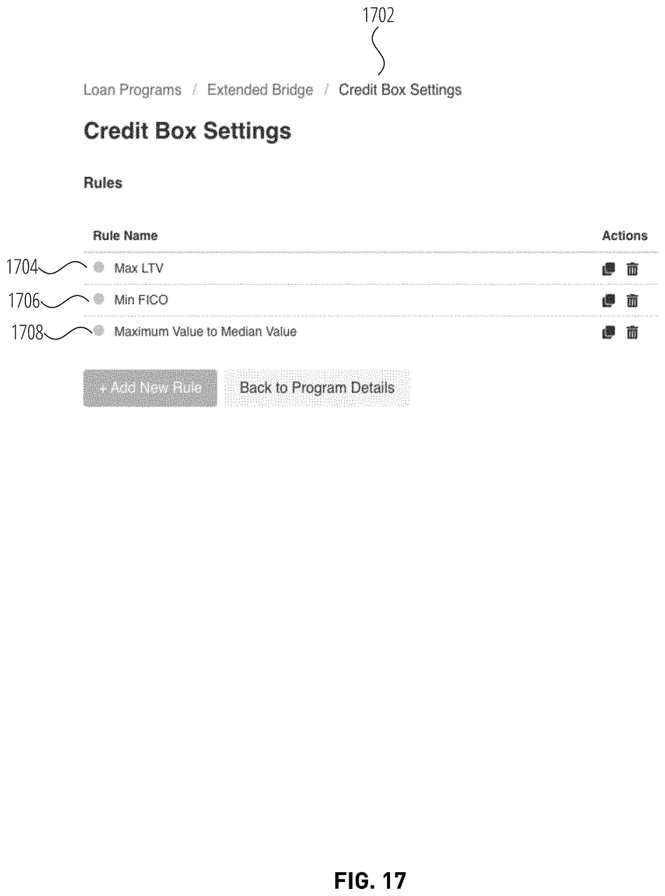

FIG. 17 illustrates an example of credit box settings 1702 in accordance with one example embodiment. The credit box settings 1702 describes the rules of the loan program 1602: rule 1704, rule 1706, and rule 1708.

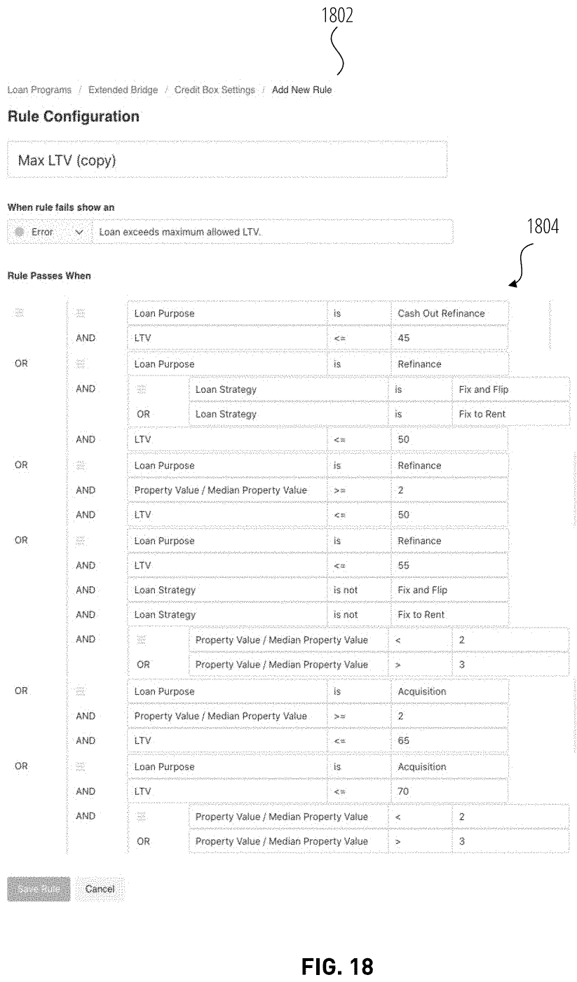

FIG. 18 illustrates an example of a rule configuration 1802 in accordance with one example embodiment. The rule configuration 1802 illustrates rules parameters 1804.

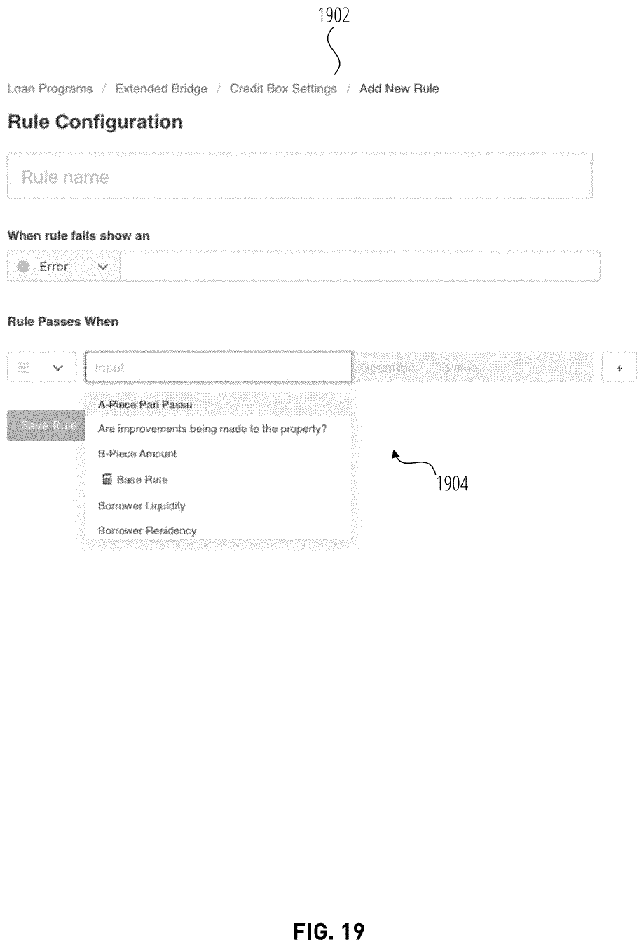

FIG. 19 illustrates another example of a product rule configuration in accordance with one example embodiment. A rule configuration 1902 illustrates rule conditions 1904.

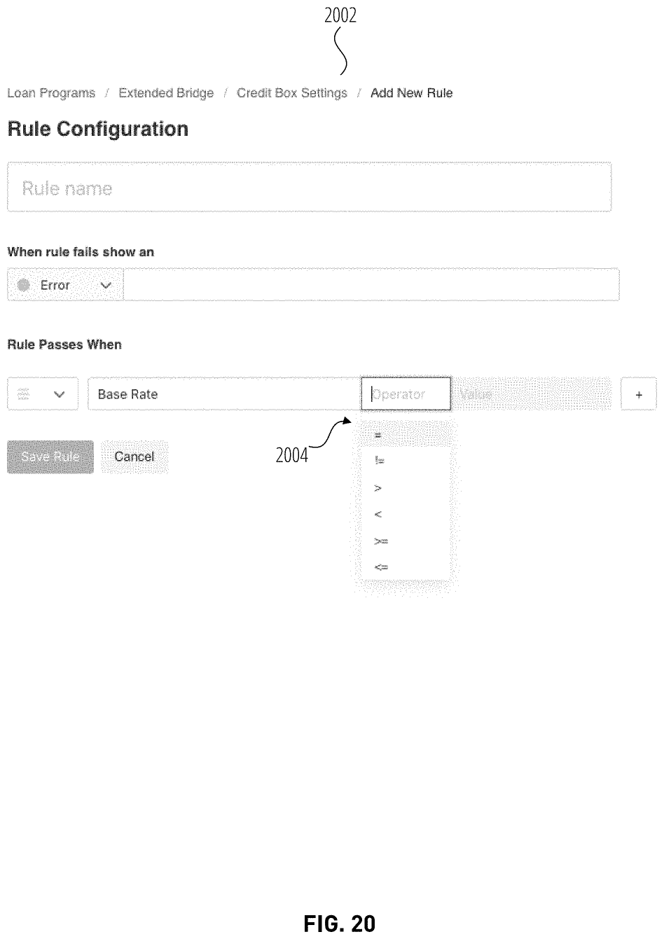

FIG. 20 illustrates an example of a product rule configuration in accordance with one example embodiment. A rule configuration 2002 illustrates a logic operator attribute 2004.

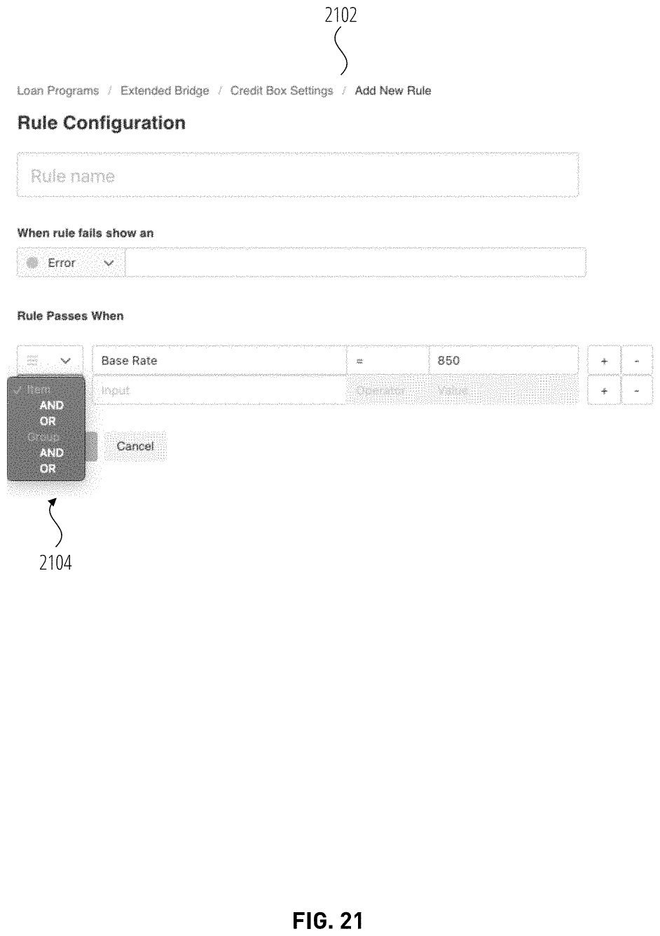

FIG. 21 illustrates an example of a product rule configuration in accordance with one example embodiment. A rule configuration 2102 illustrates a logic operator 2104.

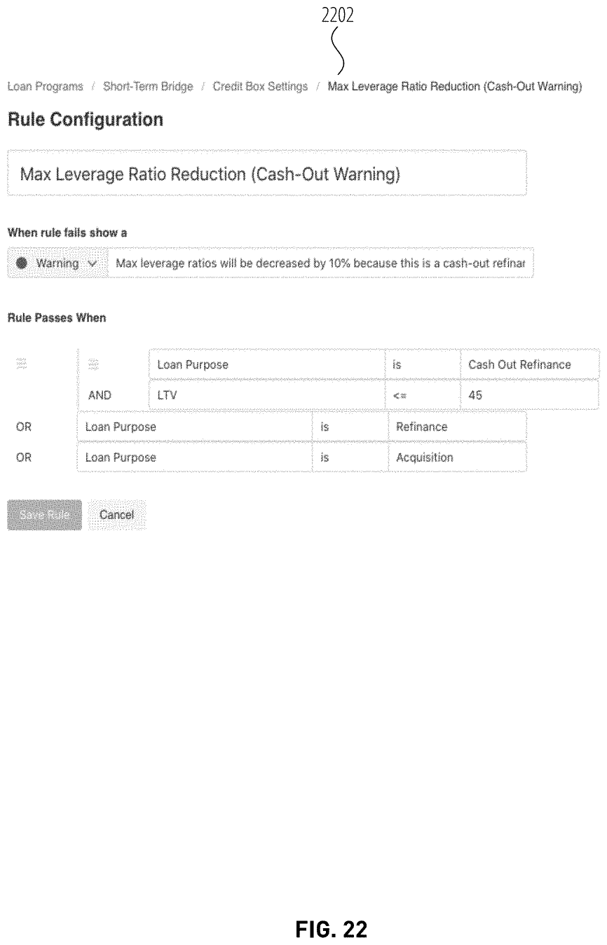

FIG. 22 illustrates an example of a rule configuration 2202 in accordance with one example embodiment.

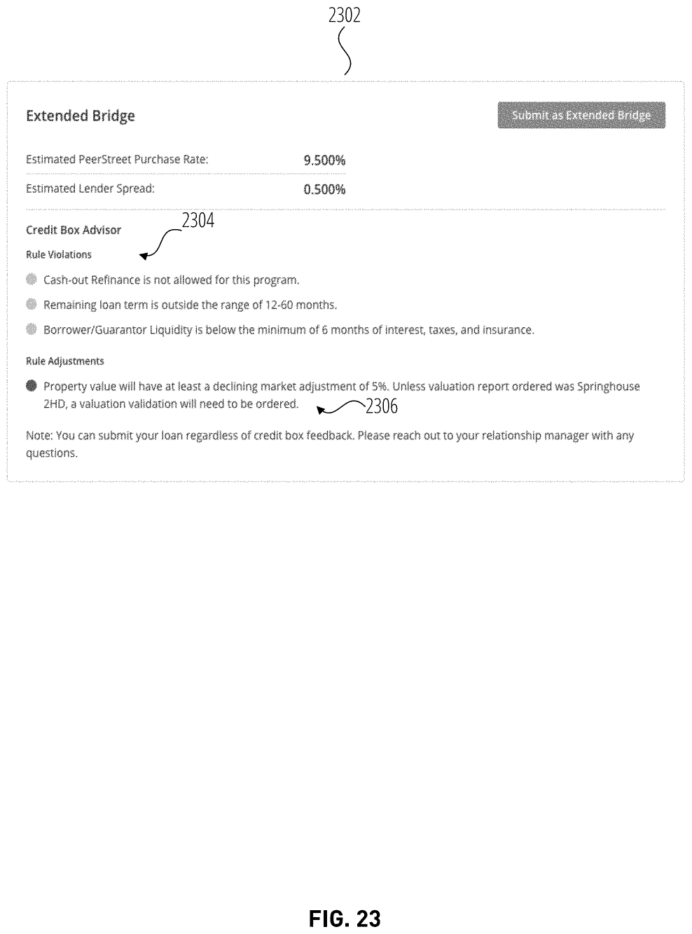

FIG. 23 illustrates an example product identifier output 2302 in accordance with one example embodiment. The product identifier output 2302 illustrates rule violations 2304 and a parameter changes suggestion 2306.

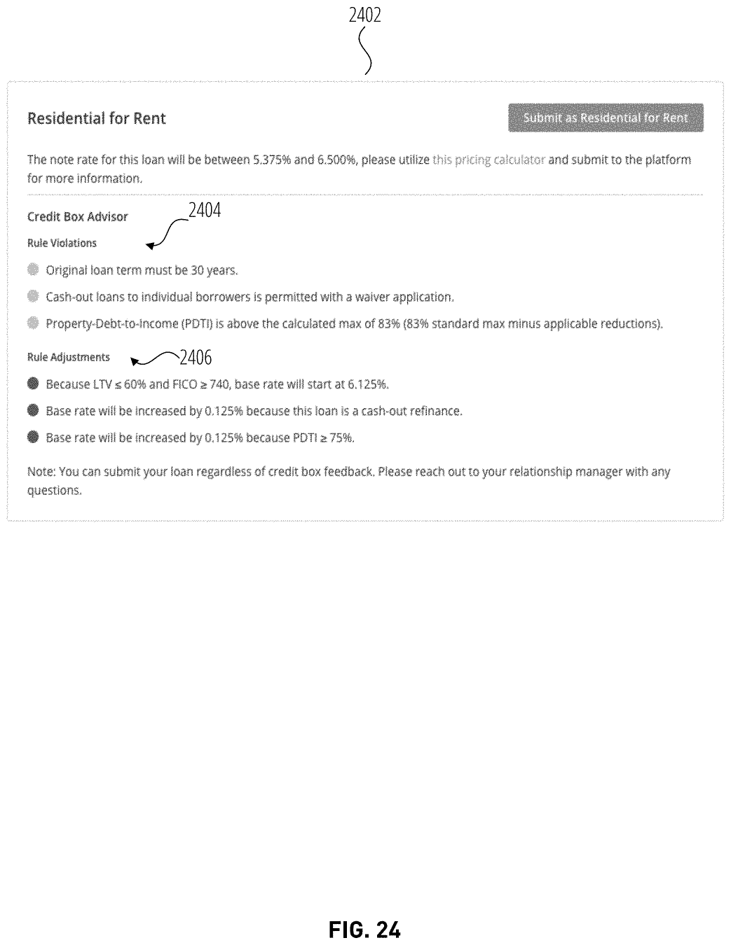

FIG. 24 illustrates an example product identifier output 2402 in accordance with one example embodiment. The product identifier output 2402 illustrates rule violations 2404 and parameters suggestions 2406.

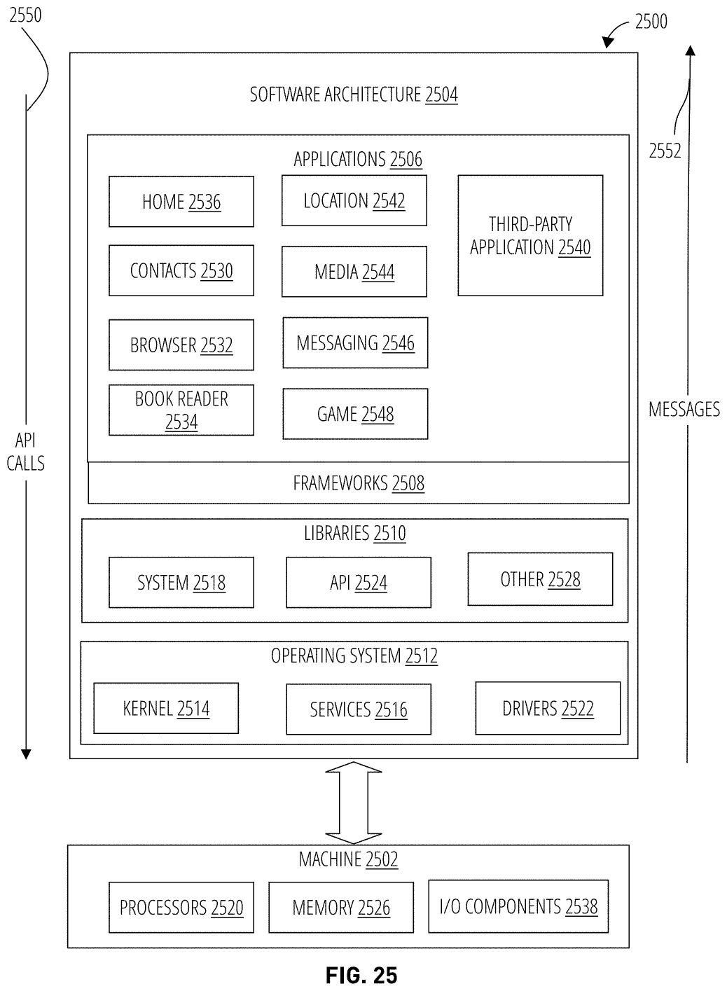

FIG. 25 is a block diagram 2500 illustrating a software architecture 2504, which can be installed on any one or more of the devices described herein. The software architecture 2504 is supported by hardware such as a machine 2502 that includes processors 2520, memory 2526, and I/O components 2538. In this example, the software architecture 2504 can be conceptualized as a stack of layers, where each layer provides a particular functionality. The software architecture 2504 includes layers such as an operating system 2512, libraries 2510, frameworks 2508, and applications 2506. Operationally, the applications 2506 invoke API calls 2550 through the software stack and receive messages 2552 in response to the API calls 2550.

The operating system 2512 manages hardware resources and provides common services. The operating system 2512 includes, for example, a kernel 2514, services 2516, and drivers 2522. The kernel 2514 acts as an abstraction layer between the hardware and the other software layers. For example, the kernel 2514 provides memory management, processor management (e.g., scheduling), component management, networking, and security settings, among other functionality. The services 2516 can provide other common services for the other software layers. The drivers 2522 are responsible for controlling or interfacing with the underlying hardware. For instance, the drivers 2522 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 2510 provide a low-level common infrastructure used by the applications 2506. The libraries 2510 can include system libraries 2518 (e.g., C standard library) that provide functions such as memory allocation functions, string manipulation functions, mathematic functions, and the like. In addition, the libraries 2510 can include API libraries 2524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 2510 can also include a wide variety of other libraries 2528 to provide many other APIs to the applications 2506.

The frameworks 2508 provide a high-level common infrastructure that is used by the applications 2506. For example, the frameworks 2508 provide various graphical user interface (GUI) functions, high-level resource management, and high-level location services. The frameworks 2508 can provide a broad spectrum of other APIs that can be used by the applications 2506, some of which may be specific to a particular operating system or platform.

In an example embodiment, the applications 2506 may include a home application 2536, a contacts application 2530, a browser application 2532, a book reader application 2534, a location application 2542, a media application 2544, a messaging application 2546, a game application 2548, and a broad assortment of other applications such as a third-party application 2540. The applications 2506 are programs that execute functions defined in the programs. Various programming languages can be employed to create one or more of the applications 2506, structured in a variety of manners, such as object-oriented programming languages (e.g., Objective-C, Java, or C++) or procedural programming languages (e.g., C or assembly language). In a specific example, the third-party application 2540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2540 can invoke the API calls 2550 provided by the operating system 2512 to facilitate functionality described herein.

FIG. 26 is a diagrammatic representation of the machine 2600 within which instructions 2608 (e.g., software, a program, an application, an applet, an app, or other executable code) for causing the machine 2600 to perform any one or more of the methodologies discussed herein may be executed. For example, the instructions 2608 may cause the machine 2600 to execute any one or more of the methods described herein. The instructions 2608 transform the general, non-programmed machine 2600 into a particular machine 2600 programmed to carry out the described and illustrated functions in the manner described. The machine 2600 may operate as a standalone device or may be coupled (e.g., networked) to other machines. In a networked deployment, the machine 2600 may operate in the capacity of a server machine or a client machine in a server-client network environment, or as a peer machine in a peer-to-peer (or distributed) network environment. The machine 2600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2608, sequentially or otherwise, that specify actions to be taken by the machine 2600. Further, while only a single machine 2600 is illustrated, the term “machine” shall also be taken to include a collection of machines that individually or jointly execute the instructions 2608 to perform any one or more of the methodologies discussed herein.

The machine 2600 may include processors 2602, memory 2604, and I/O components 2642, which may be configured to communicate with each other via a bus 2644. In an example embodiment, the processors 2602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 2606 and a processor 2610 that execute the instructions 2608. The term “processor” is intended to include multi-core processors that may comprise two or more independent processors (sometimes referred to as “cores”) that may execute instructions contemporaneously. Although FIG. 26 shows multiple processors 2602, the machine 2600 may include a single processor with a single core, a single processor with multiple cores (e.g., a multi-core processor), multiple processors with a single core, multiple processors with multiples cores, or any combination thereof.

The memory 2604 includes a main memory 2612, a static memory 2614, and a storage unit 2616, both accessible to the processors 2602 via the bus 2644. The main memory 2604, the static memory 2614, and storage unit 2616 store the instructions 2608 embodying any one or more of the methodologies or functions described herein. The instructions 2608 may also reside, completely or partially, within the main memory 2612, within the static memory 2614, within machine-readable medium 2618 within the storage unit 2616, within at least one of the processors 2602 (e.g., within the processor's cache memory), or any suitable combination thereof, during execution thereof by the machine 2600.

The I/O components 2642 may include a wide variety of components to receive input, provide output, produce output, transmit information, exchange information, capture measurements, and so on. The specific I/O components 2642 that are included in a particular machine will depend on the type of machine. For example, portable machines such as mobile phones may include a touch input device or other such input mechanisms, while a headless server machine will likely not include such a touch input device. It will be appreciated that the I/O components 2642 may include many other components that are not shown in FIG. 26. In various example embodiments, the I/O components 2642 may include output components 2628 and input components 2630. The output components 2628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 2642 may include biometric components 2632, motion components 2634, environmental components 2636, or position components 2638, among a wide array of other components. For example, the biometric components 2632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2634 include acceleration sensor components (e.g., accelerometer), gravitation sensor components, rotation sensor components (e.g., gyroscope), and so forth. The environmental components 2636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2642 further include communication components 2640 operable to couple the machine 2600 to a network 2620 or devices 2622 via a coupling 2624 and a coupling 2626, respectively. For example, the communication components 2640 may include a network interface component or another suitable device to interface with the network 2620. In further examples, the communication components 2640 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2622 may be another machine or any of a wide variety of peripheral devices (e.g., a peripheral device coupled via a USB).

Moreover, the communication components 2640 may detect identifiers or include components operable to detect identifiers. For example, the communication components 2640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2640, such as location via Internet Protocol (IP) geolocation, location via Wi-Fi® signal triangulation, location via detecting an NFC beacon signal that may indicate a particular location, and so forth.

The various memories (e.g., memory 2604, main memory 2612, static memory 2614, and/or memory of the processors 2602) and/or storage unit 2616 may store one or more sets of instructions and data structures (e.g., software) embodying or used by any one or more of the methodologies or functions described herein. These instructions (e.g., the instructions 2608), when executed by processors 2602, cause various operations to implement the disclosed embodiments.

The instructions 2608 may be transmitted or received over the network 2620, using a transmission medium, via a network interface device (e.g., a network interface component included in the communication components 2640) and using any one of a number of well-known transfer protocols (e.g., hypertext transfer protocol (HTTP)). Similarly, the instructions 2608 may be transmitted or received using a transmission medium via the coupling 2626 (e.g., a peer-to-peer coupling) to the devices 2622.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Examples

Example 1 is a computer-implemented method comprising: receiving, from a client device, a definition of a product via a web page of a product configuration platform, the definition identifying attributes of the product; providing a rule configuration template in the web page of the product; receiving, at a server, entries in the rule configuration template, the entries indicating values for corresponding rule attributes of the rule configuration template; forming a product rule configuration based on the entries in the rule configuration template; and generating, at the server, a programming object based on the definition of the product and the product rule configuration.

Example 2 includes example 1, further comprising: accessing a core rules library that defines acceptable entries in the rule configuration template; and validating the entries in the rule configuration template based on the core rules library, wherein generating the programming object is in response to validating the entries.

Example 3 includes example 1, further comprising: accessing a core rules library that defines an acceptable range of a rule attribute in the rule configuration template; determining an invalid entry in the rule configuration template based on a value of the invalid entry being outside the acceptable range of the rule attribute; and identifying the invalid entry in the web page for the product.

Example 4 includes example 3, further comprising: presenting a rule attribute value suggestion that remedies the invalid entry based on the acceptable range of the rule attribute.

Example 5 includes example 4, further comprising: receiving an updated rule attribute value in the rule configuration template; and updating the programming object is in response to receiving the updated rule attribute value.

Example 6 includes example 1, further comprising: accessing a core rules library that defines an acceptable range of a rule attribute in the rule configuration template; determining an invalid rule in the rule configuration template based on a value of the rule attribute being outside the acceptable range of the rule attribute; and identifying the invalid rule in the web page for the product.

Example 7 includes example 1, further comprising: receiving, at the server, a product query that indicates product parameters; identifying, a first product that was formed with the product configuration platform, based on the product parameters; identifying the rules of the first product; and generating a graphical user interface that identifies the first product and indicates that the rules of the first product are validated by the product parameters.

Example 8 includes example 7, further comprising: detecting a selection of the first product from the client device; assigning a product instance identifier to the first product; and recording, in the programming object, rules configuration of the first product associated with the product instance identifier of the first product.

Example 9 includes example 8, further comprising: receiving, at the server, a rules configuration request that identifies the product instance identifier of the first product; and identifying the rules configuration associated with the product instance identifier of the first product.

Example 10 includes example 9, further comprising: tracking a status of the first product instance, the first product, or the rules of the rules configuration of the first product; determining that a rule of the rules configuration or the first product is expiring within a threshold time window; and generating an alert notification based on the rule expiring within the threshold time window.

Example 11 includes example 1, further comprising: receiving, at the server, a product query that indicates product parameters; identifying, a first product that was formed with the product configuration platform, based on the product parameters; identifying the rules of the first product; and generating a graphical user interface that identifies the first product and indicates a rule of the first product that is not validated by the product parameters.

Example 12 includes example 11, further comprising: presenting in the graphical user interface, suggested product parameters that remedy the rule of the first product.

Example 13 includes example 1, further comprising: receiving, at the server, a product query that indicates product parameters; identifying, a plurality of products that were formed with the product configuration platform, based on the product parameters; ranking the plurality of products based on a number validated rules for each product; and generating a graphical user interface that identifies the ranked plurality of products.

Example 14 includes example 1, wherein the rule configuration template indicates rule attributes of the product and one or more operators between the rule attributes of the product.

Example 15 includes example 1, further comprising: receiving an identification of an operator in entries in the rule configuration template, the operator identifying a relationship between a first rule attribute of the product and a second rule attribute of the product.

Example 16 is a computing apparatus comprising: a processor; and a memory storing instructions that, when executed by the processor, configure the apparatus to: receive, from a client device, a definition of a product via a web page of a product configuration platform, the definition identifying attributes of the product; provide a rule configuration template in the web page of the product; receive, at a server, entries in the rule configuration template, the entries indicating values for corresponding rule attributes of the rule configuration template; form a product rule configuration based on the entries in the rule configuration template; and generate, at the server, a programming object based on the definition of the product and the product rule configuration.

Example 17 includes example 16, wherein the instructions further configure the apparatus to: access a core rules library that defines acceptable entries in the rule configuration template; and validate the entries in the rule configuration template based on the core rules library, wherein generating the programming object is in response to validating the entries.

Example 18 includes example 16, wherein the instructions further configure the apparatus to: access a core rules library that defines an acceptable range of a rule attribute in the rule configuration template; determine an invalid entry in the rule configuration template based on a value of the invalid entry being outside the acceptable range of the rule attribute; and identify the invalid entry in the web page for the product.

Example 19 includes example 18, wherein the instructions further configure the apparatus to: present a rule attribute value suggestion that remedies the invalid entry based on the acceptable range of the rule attribute.

Example 20 is a non-transitory computer-readable storage medium, the computer-readable storage medium including instructions that when executed by a computer, cause the computer to: receive, from a client device, a definition of a product via a web page of a product configuration platform, the definition identifying attributes of the product; provide a rule configuration template in the web page of the product; receive, at a server, entries in the rule configuration template, the entries indicating values for corresponding rule attributes of the rule configuration template; form a product rule configuration based on the entries in the rule configuration template; and generate, at the server, a programming object based on the definition of the product and the product rule configuration.

What is claimed is:

1. A computer-implemented method comprising:
receiving, from a client device, a definition of a product via a web page of a product configuration platform, the definition identifying attributes of the product;
providing a rule configuration template in the web page of the product;
receiving, at a server, entries in the rule configuration template, the entries indicating values for corresponding rule attributes of the rule configuration template;
forming a product rule configuration based on the entries in the rule configuration template; and
generating, at the server, a programming object based on the definition of the product and the product rule configuration.

2. The computer-implemented method of claim 1, further comprising:
accessing a core rules library that defines acceptable entries in the rule configuration template; and
validating the entries in the rule configuration template based on the core rules library, wherein generating the programming object is in response to validating the entries.

3. The computer-implemented method of claim 1, further comprising:
accessing a core rules library that defines an acceptable range of a rule attribute in the rule configuration template;
determining an invalid entry in the rule configuration template based on a value of the invalid entry being outside the acceptable range of the rule attribute; and
identifying the invalid entry in the web page for the product.

4. The computer-implemented method of claim 3, further comprising:
presenting a rule attribute value suggestion that remedies the invalid entry based on the acceptable range of the rule attribute.

5. The computer-implemented method of claim 4, further comprising:
receiving an updated rule attribute value in the rule configuration template; and
updating the programming object is in response to receiving the updated rule attribute value.

6. The computer-implemented method of claim 1, further comprising:
accessing a core rules library that defines an acceptable range of a rule attribute in the rule configuration template;
determining an invalid rule in the rule configuration template based on a value of the rule attribute being outside the acceptable range of the rule attribute; and
identifying the invalid rule in the web page for the product.

7. The computer-implemented method of claim 1, further comprising:
receiving, at the server, a product query that indicates product parameters;
identifying, a first product that was formed with the product configuration platform, based on the product parameters;
identifying rules of the first product; and
generating a graphical user interface that identifies the first product and indicates that the rules of the first product are validated by the product parameters.

8. The computer-implemented method of claim 7, further comprising:
detecting a selection of the first product from the client device;
assigning a product instance identifier to the first product; and
recording, in the programming object, rules configuration of the first product associated with the product instance identifier of the first product.

9. The computer-implemented method of claim 8, further comprising:
receiving, at the server, a rules configuration request that identifies the product instance identifier of the first product; and
identifying the rules configuration associated with the product instance identifier of the first product.

10. The computer-implemented method of claim 9, further comprising:
tracking a status of the first product instance, the first product, or rules of the rules configuration of the first product;
determining that a rule of the rules configuration or the first product is expiring within a threshold time window; and
generating an alert notification based on the rule expiring within the threshold time window.

11. The computer-implemented method of claim 1, further comprising:
receiving, at the server, a product query that indicates product parameters;
identifying, a first product that was formed with the product configuration platform, based on the product parameters;
identifying the rules of the first product; and
generating a graphical user interface that identifies the first product and indicates a rule of the first product that is not validated by the product parameters.

12. The computer-implemented method of claim 11, further comprising:
presenting in the graphical user interface, suggested product parameters that remedy the rule of the first product.

13. The computer-implemented method of claim 1, further comprising:
receiving, at the server, a product query that indicates product parameters;
identifying, a plurality of products that were formed with the product configuration platform, based on the product parameters;
ranking the plurality of products based on a number validated rules for each product; and
generating a graphical user interface that identifies the ranked plurality of products.

14. The computer-implemented method of claim 1, wherein the rule configuration template indicates rule attributes of the product and one or more operators between the rule attributes of the product.

15. The computer-implemented method of claim 1, further comprising:
receiving an identification of an operator in entries in the rule configuration template, the operator identifying a relationship between a first rule attribute of the product and a second rule attribute of the product.

16. A computing apparatus comprising:
a processor; and
a memory storing instructions that, when executed by the processor, configure the apparatus to:
receive, from a client device, a definition of a product via a web page of a product configuration platform, the definition identifying attributes of the product;
provide a rule configuration template in the web page of the product;
receive, at a server, entries in the rule configuration template, the entries indicating values for corresponding rule attributes of the rule configuration template;
form a product rule configuration based on the entries in the rule configuration template; and
generate, at the server, a programming object based on the definition of the product and the product rule configuration.

17. The computing apparatus of claim 16, wherein the instructions further configure the apparatus to:
access a core rules library that defines acceptable entries in the rule configuration template; and
validate the entries in the rule configuration template based on the core rules library,
wherein generating the programming object is in response to validating the entries.

18. The computing apparatus of claim 16, wherein the instructions further configure the apparatus to:
access a core rules library that defines an acceptable range of a rule attribute in the rule configuration template;
determine an invalid entry in the rule configuration template based on a value of the invalid entry being outside the acceptable range of the rule attribute; and
identify the invalid entry in the web page for the product.

19. The computing apparatus of claim 18, wherein the instructions further configure the apparatus to:
present a rule attribute value suggestion that remedies the invalid entry based on the acceptable range of the rule attribute.

20. A non-transitory computer-readable storage medium, the computer-readable storage medium including instructions that when executed by a computer, cause the computer to:
receive, from a client device, a definition of a product via a web page of a product configuration platform, the definition identifying attributes of the product;
provide a rule configuration template in the web page of the product;
receive, at a server, entries in the rule configuration template, the entries indicating values for corresponding rule attributes of the rule configuration template;
form a product rule configuration based on the entries in the rule configuration template; and
generate, at the server, a programming object based on the definition of the product and the product rule configuration.
